(19) United States
(12) Patent Application Publication
(10) Pub. No.: US 2018/0354503 A1
(43) Pub. Date: Dec. 13, 2018

(54) PARKING ASSISTANCE SYSTEM

(71) Applicant: AISIN SEIKI KABUSHIKI KAISHA, Kariya-shi (JP)

(72) Inventors: Koichi SASSA, Ichinomiya-shi (JP); Hironori HIRATA, Anjo-shi (JP); Ayumu MATSUURA, Kariya-shi (JP); Kenichi OHSHIMA, Wako-shi (JP)

(73) Assignee: AISIN SEIKI KABUSHIKI KAISHA, Kariya-shi (JP)

(21) Appl. No.: 15/992,402

(22) Filed: May 30, 2018

(30) Foreign Application Priority Data
Jun. 9, 2017 (JP) 2017-114666

(51) Int. Cl. B60W 30/06; G06K 9/00

(52) U.S. Cl. CPC B60W 30/06; G06K 9/00812

(57) ABSTRACT

According to one embodiment, a parking assistance system includes a first detector configured to detect first information that is information concerning a wheel on a left-hand side of a vehicle, a second detector configured to detect second information that is information concerning a wheel on a right-hand side of the vehicle, and a processor configured to estimate a host-vehicle location that is a location of the vehicle based on the first information and the second information in a state of traveling along a set route to a target point set in a parking area, and to calculate a correction value for correcting the set route based on a route difference that is a difference between the set route and the host-vehicle location.

### CROSS-REFERENCE TO RELATED APPLICATIONS

This application is based upon and claims the benefit of priority from Japanese Patent Application No. 2017-114666, filed Jun. 9, 2017, the entire contents of which are incorporated herein by reference.

### FIELD

Embodiments described herein relate generally to a parking assistance system.

### BACKGROUND

A parking assistance system that sets a set route to a target point in a parking area and makes a vehicle travel in automatic driving to the target point along the set route has been known. Such a parking assistance system makes the vehicle travel along the set route by controlling the steering unit, based on data for which a turning radius and the like of a turning circle included in the set route is associated with a steering angle of a steering unit such as a steering wheel. A conventional technique is described in Japanese Patent Application Laid-open No. 2010-269707, for example.

Because the vehicle characteristics of a vehicle are different for each vehicle, the above-described parking assistance system involves the problem that the actual travel route is deviated from the set route and causes the vehicle to park at a location different from the target point.

The present invention has been made in view of the aforementioned circumstances, and an object of the invention is to provide a parking assistance system capable of making a vehicle travel to the target point with high accuracy.

A parking assistance system comprising: a first detector configured to detect first information that is information concerning a wheel on a left-hand side of a vehicle; a second detector configured to detect second information that is information concerning a wheel on a right-hand side of the vehicle; and a processor configured to estimate a host-vehicle location that is a location of the vehicle based on the first information and the second information in a state of traveling along a set route to a target point set in a parking area, and to calculate a correction value for correcting the set route based on a route difference that is a difference between the set route and the host-vehicle location.

### SUMMARY

As just described, in the parking assistance system of the present invention, the detectors detect the first information and the second information concerning the actual left and right wheels, and the processor estimates the host-vehicle location from the relevant first and second information. Accordingly, the parking assistance system can calculate, based on the route difference calculated from the host-vehicle location, an appropriate correction value in response to the actual traveling and improve the accuracy of the parking to the target point.

In the parking assistance system of the present invention, the processor may make correction by offsetting at least a part of the set route in a width direction of the parking area based on the correction value.

As just described, in the parking assistance system of the present invention, because the correction is made by offsetting the set route in the width direction of the parking area, an appropriate set route can be set while suppressing an increase in calculation load in the correction processing.

In the parking assistance system of the present invention, the processor may calculate the correction value based on an interim correction value obtained by multiplying a route-difference mean value that is an mean value of the route differences, by a first correction coefficient below one.

As just described, in the parking assistance system of the present invention, because the processor calculates the correction value by multiplying the route-difference mean value by the first correction coefficient below one, even when the route-difference mean value has resulted in an abnormal value, the influence of the abnormal value on the correction value can be reduced.

In the parking assistance system of the present invention, the processor may calculate the correction value based on the interim correction value that is obtained by multiplying the route-difference mean value by a second correction coefficient smaller than the first correction coefficient when variance of the route difference or the route-difference mean value is equal to or greater than a preset variance threshold.

As just described, in the parking assistance system of the present invention, when the variance of the route-difference mean value or the like is large, because the processor calculates the correction value by multiplying by the second correction coefficient smaller than the first correction coefficient, the influence of an inappropriate route-difference mean value and the like on the correction value can be reduced.

In the parking assistance system of the present invention, the processor may calculate the correction value for each pattern of a plurality of patterns of the set route from the route difference calculated based on a difference calculation method associated with each pattern.

Accordingly, in the parking assistance system of the present invention, because the processor can calculate an appropriate correction value associated with the route difference that is different for each pattern, the parking assistance along the set route more appropriately corrected for each pattern can be executed.

In the parking assistance system of the present invention, the processor may calculate the correction value based on a difference between the target point and an actual stop location in a vehicle width direction of the parking area.

Accordingly, in the parking assistance system of the present invention, the target point and the stop location can be made closer.

In the parking assistance system of the present invention, the processor may calculate the correction value by adopting the route difference of a case in which a vehicle speed of the vehicle is below a preset vehicle speed threshold.

Accordingly, in the parking assistance system of the present invention, by the route difference in a low speed condition that is appropriate for the correction, the accuracy of the correction value can be improved.

In the parking assistance system of the present invention, the processor may calculate the correction value by adopting the route difference of a case in which a difference between the target point and an actual stop location in a length direction of the parking area is below a difference threshold.

Accordingly, in the parking assistance system of the present invention, by eliminating the route difference that was increased by the factors other than the actual directions of the wheels, the accuracy of the correction value can be improved by the appropriate route difference.

### BRIEF DESCRIPTION OF THE DRAWINGS

FIG. 1 is a plan view of a vehicle in which a parking assistance system of an embodiment is installed;

FIG. 2 is a block diagram illustrating an overall configuration of the parking assistance system of the embodiment;

FIG. 3 is a functional block diagram for explaining functions of a parking assistance device;

FIG. 4 is a diagram illustrating one example of a steering table;

FIG. 5 is a diagram illustrating a set route before correction and a travel route;

FIG. 6 is a diagram illustrating a set route after correction and the travel route;

FIG. 7 is a diagram for explaining one example of a method of estimating a host-vehicle location by an estimation unit;

FIG. 8 is a graph illustrating the relation between a route-difference mean value and the number of times of calculation;

FIG. 9 is a graph illustrating the relation between a correction value and the number of times of calculation;

FIG. 10 is a flowchart of driving control processing in parking assistance processing that a driving controller of a processing unit executes;

FIG. 11 is a flowchart of correction processing in the parking assistance processing that the estimation unit and a correction unit of the processing unit execute;

FIG. 12 is a diagram for explaining a method of calculating a route difference in a first modification;

FIG. 13 is a diagram illustrating one example of a set route to which correction processing in a second modification is applied; and

FIG. 14 is a flowchart of correction processing in the second modification.

### DETAILED DESCRIPTION

In the following exemplary embodiment and the like, the same constituent elements are denoted by common reference signs and the redundant explanations thereof are omitted as appropriate.

### Embodiment

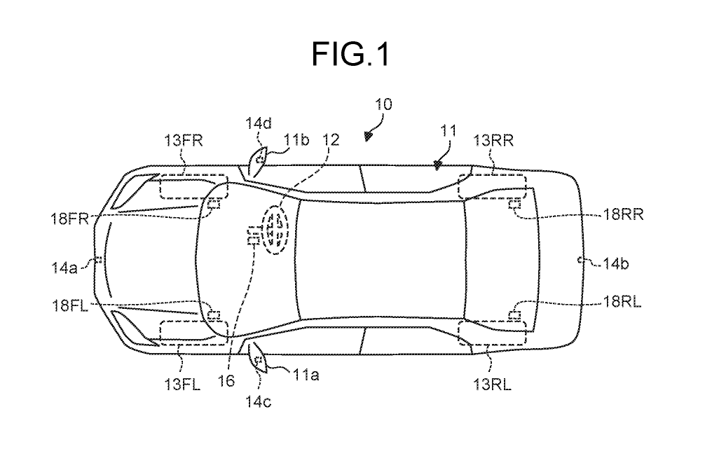

FIG. 1 is a plan view of a vehicle 10 in which a parking assistance system of an embodiment is installed. The vehicle 10, for example, may be an automobile with an internal combustion engine (an engine, not depicted) as a drive source (an internal combustion engine vehicle), may be an automobile with an electric motor (a motor, not depicted) as a drive source (an electric vehicle, a fuel-cell vehicle, or the like), or may be an automobile with both of the foregoing as a drive source (a hybrid vehicle). The vehicle 10 can be equipped with a transmission of various types and can be equipped with various devices (systems, components, and others) needed to drive the internal combustion engine or the electric motor. The method, the number, the layout, and others of the devices concerning the drive of wheels 13 in the vehicle 10 can be configured in various ways.

As illustrated in FIG. 1, the vehicle 10 includes a vehicle body 11, a steering unit 12, four wheels 13FL, 13FR, 13RL, and 13RR, one or more of (four, in the present embodiment) image capturing units 14a, 14b, 14c, and 14d, a steering unit sensor 16, and a plurality of (four, in the embodiment) wheel speed sensors 18FL, 18FR, 18RL, and 18RR. The wheels 13FL, 13FR, 13RL, and 13RR will be described as wheels 13 when there is no need to distinguish them. The image capturing units 14a, 14b, 14c, and 14d will be described as image capturing units 14 when there is no need to distinguish them. The wheel speed sensors 18FL, 18FR, 18RL, and 18RR will be described as wheel speed sensors 18 when there is no need to distinguish them.

The vehicle body 11 constitutes a vehicle interior in which an occupant rides. The vehicle body 11 accommodates or retains the wheels 13, the steering unit 12, the image capturing units 14, the steering unit sensor 16, the wheel speed sensors 18, and others.

The steering unit 12 includes, for example, a handle, a steering wheel, or the like, and is a device that operates the turning wheels (for example, the wheels 13FL, 13FR) of the vehicle 10.

The wheel 13FL is provided on the front left of the vehicle 10. The wheel 13FR is provided on the front right of the vehicle 10. The wheel 13RL is provided on the rear left of the vehicle 10. The wheel 13RR is provided on the rear right of the vehicle 10. The two wheels 13FL and 13FR on the front side are steered by the steering unit 12 and function as the turning wheels that change the advancing direction of the vehicle 10. The two wheels 13RL and 13RR on the rear side function as driving wheels that rotate by the drive force from the engine, the motor, or the like, for example.

The image capturing units 14 are digital cameras that have a built-in imaging element such as a charge-coupled device (CCD), a CMOS image sensor (CIS), or the like, for example. The image capturing units 14 output, as data of a captured image, data of a still image or of a moving image including a plurality of frame images generated at a certain frame rate. The image capturing units 14 each have each a wide-angle lens or a fish-eye lens and are capable of photographing a range of 140° to 190° in the horizontal direction. The optical axes of the image capturing units 14 are set obliquely downward. Accordingly, the image capturing units 14 output the data of a captured image in which the periphery of the vehicle 10 including the road surface of the periphery is imaged.

The image capturing units 14 are provided around the vehicle body 11. For example, the image capturing unit 14a is provided at the central portion of the left-and-right direction in the front-end portion (for example, a front bumper) of the vehicle body 11. The image capturing unit 14a generates a captured image in which the periphery of the front of the vehicle 10 is imaged. The image capturing unit 14b is provided at the central portion of the left-and-right direction in the rear-end portion (for example, a rear bumper) of the vehicle body 11. The image capturing unit 14b generates a captured image in which the periphery of the rear of the vehicle 10 is imaged. The image capturing unit 14c is provided at the central portion of the front-and-rear direction in the left-end portion (for example, a side mirror 11a on the left-hand side) of the vehicle body 11. The image capturing unit 14c generates a captured image in which the periphery of the left-hand side of the vehicle 10 is imaged. The image capturing unit 14d is provided at the central portion of the front-and-rear direction in the right-end portion (for example, a side mirror 11b on the right-hand side) of the vehicle body 11. The image capturing unit 14d generates a captured image in which the periphery of the right-hand side of the vehicle 10 is imaged.

The steering unit sensor 16 is provided near the steering unit 12. The steering unit sensor 16 is an angle sensor including, for example, a hall element or the like and outputs a detected rotation angle of the steering unit 12 as a detected steering angle.

The wheel speed sensors 18 include a hall element provided near the respective wheels 13 and are sensors that detect the rotation amount of the wheel 13 or the number of revolutions thereof per unit time.

The wheel speed sensor 18FL is provided near the wheel 13FL on the front left. The wheel speed sensor 18FL detects and outputs wheel speed pulses associated with the rotation amount of the wheel 13FL or the number of revolutions per unit time, as front-left rotational information that is the information concerning the rotation of the wheel 13FL.

The wheel speed sensor 18FR is provided near the wheel 13FR on the front right. The wheel speed sensor 18FR detects and outputs wheel speed pulses associated with the rotation amount of the wheel 13FR or the number of revolutions per unit time, as front-right rotational information that is the information concerning the rotation of the wheel 13FR.

The wheel speed sensor 18RL is an example of a first detector and is provided near the wheel 13RL on the rear left. The wheel speed sensor 18RL detects and outputs wheel speed pulses associated with the rotation amount of the wheel 13RL or the number of revolutions per unit time, as rear-left rotational information that is the information concerning the rotation of the wheel 13RL. The rear-left rotational information is one example of first information that is the information concerning the wheel 13 on the left-hand side.

The wheel speed sensor 18RR is an example of a second detector and is provided near the wheel 13RR on the rear right. The wheel speed sensor 18RR detects and outputs wheel speed pulses associated with the rotation amount of the wheel 13RR or the number of revolutions per unit time, as rear-right rotational information that is the information concerning the rotation of the wheel 13RR. The rear-right rotational information is one example of second information that is the information concerning the wheel 13 on the right-hand side.

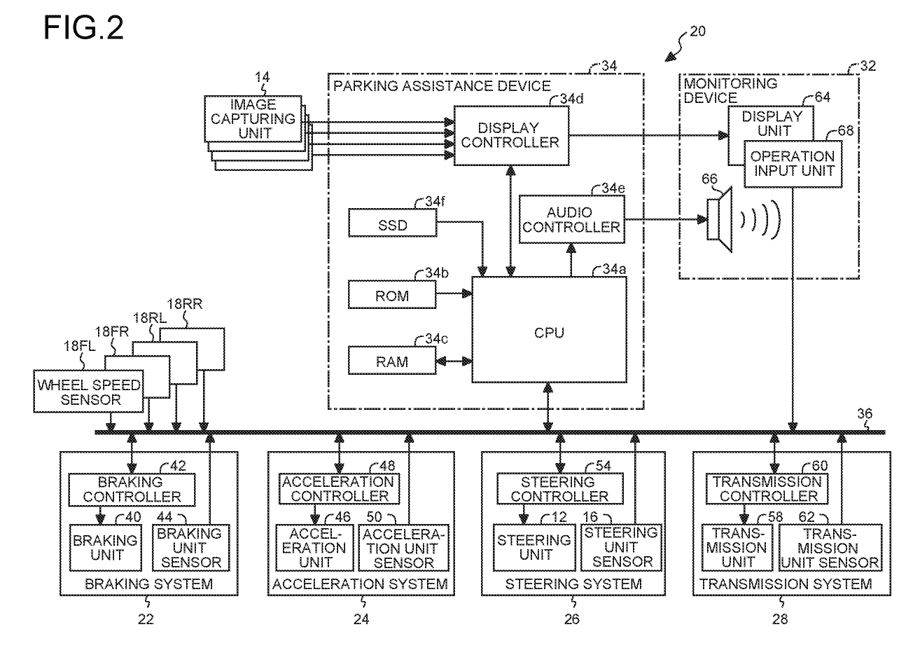

FIG. 2 is a block diagram illustrating an overall configuration of a parking assistance system 20 in the embodiment. The parking assistance system 20 is installed on the vehicle 10 and assists a driver by performing automatic driving (including partial automatic driving) of the vehicle 10. In addition, the parking assistance system 20 corrects a set route SR that is set for automatic driving and causes the vehicle 10 to travel to an ideal location in a parking area.

As illustrated in FIG. 2, the parking assistance system 20 includes the image capturing units 14, the wheel speed sensors 18, a braking system 22, an acceleration system 24, a steering system 26, a transmission system 28, a monitoring device 32, a parking assistance device 34, and an in-vehicle network 36.

The image capturing units 14 output captured images in which the periphery of the vehicle 10 is imaged to the parking assistance device 34.

The wheel speed sensors 18 output the detected rotational information to the in-vehicle network 36.

The braking system 22 controls the deceleration of the vehicle 10. The braking system 22 includes a braking unit 40, a braking controller 42, and a braking unit sensor 44.

The braking unit 40, for example, includes brakes, a brake pedal, and others, and is a device for making the vehicle 10 decelerate.

The braking controller 42 is a computer that includes a microcomputer such as an electronic control unit (ECU) having a hardware processor such as a central processing unit (CPU), for example. The braking controller 42 controls the braking unit 40 based on instructions from the parking assistance device 34, thereby controlling the deceleration of the vehicle 10.

The braking unit sensor 44 is, for example, a position sensor and, when the braking unit 40 is the brake pedal, detects the position of the braking unit 40. The braking unit sensor 44 outputs the detected state of the braking unit 40 to the in-vehicle network 36.

The acceleration system 24 controls the acceleration of the vehicle 10. The acceleration system 24 includes an acceleration unit 46, an acceleration controller 48, and an acceleration unit sensor 50.

The acceleration unit 46 includes, for example, an acceleration pedal and others, and is a device for making the vehicle 10 accelerate.

The acceleration controller 48 is a computer that includes a microcomputer such as an ECU having a hardware processor such as a CPU, for example. The acceleration controller 48 controls the acceleration unit 46 based on the instructions from the parking assistance device 34, thereby controlling the acceleration of the vehicle 10.

The acceleration unit sensor 50 is, for example, a position sensor and, when the acceleration unit 46 is the acceleration pedal, detects the position of the acceleration unit 46. The acceleration unit sensor 50 outputs the detected state of the acceleration unit 46 to the in-vehicle network 36.

The steering system 26 controls the advancing direction of the vehicle 10. The steering system 26 includes the steering unit 12, a steering controller 54, and the steering unit sensor 16.

The steering controller 54 is a computer that includes a microcomputer such as an ECU having a hardware processor such as a CPU, for example. The steering controller 54 controls the steering unit 12 based on a steering angle that is instructed from the parking assistance device 34, thereby controlling the advancing direction of the vehicle 10.

The steering unit sensor 16 outputs the detected steering angle of the steering unit 12 to the in-vehicle network 36.

The transmission system 28 controls a transmission gear ratio of the vehicle 10. The transmission system 28 includes a transmission unit 58, a transmission controller 60, and a transmission unit sensor 62.

The transmission unit 58 includes, for example, a shift lever and others, and is a device that changes the transmission gear ratio and others of the vehicle 10.

The transmission controller 60 is a computer that includes a microcomputer such as an ECU having a hardware processor such as a CPU, for example. The transmission controller 60 controls the transmission unit 58 based on the instructions from the parking assistance device 34, thereby controlling the transmission gear ratio and others of the vehicle 10.

The transmission unit sensor 62 detects the position of the transmission unit 58 such as drive, parking, reverse, and others. The transmission unit sensor 62 outputs the detected position of the transmission unit 58 to the in-vehicle network 36.

The monitoring device 32 is provided in a dashboard and the like in the vehicle interior of the vehicle 10. The monitoring device 32 includes a display unit 64, an audio output unit 66, and an operation input unit 68.

The display unit 64 displays an image based on image data that the parking assistance device 34 transmitted. The display unit 64 is a display device such as a liquid crystal display (LCD), an organic electroluminescent display (OELD), or the like, for example. The display unit 64 displays an image such as a parking area or the like to receive switching from manual driving to automatic driving, for example.

The audio output unit 66 outputs sound based on audio data that the parking assistance device 34 transmitted. The audio output unit 66 is a speaker, for example. The audio output unit 66 outputs sound such as guidance to automatic driving, for example.

The operation input unit 68 receives the input of the occupant. The operation input unit 68 is a touch panel, for example. The operation input unit 68 is provided on a display screen of the display unit 64. The operation input unit 68 is configured such that an image that the display unit 64 displays can be transmitted through it. Accordingly, the operation input unit 68 can let the occupant visually recognize the image displayed on the display screen of the display unit 64. The operation input unit 68 receives instructions concerning the parking assistance and others that are input as the occupant touches positions corresponding to the image displayed on the display screen of the display unit 64, and the operation input unit 68 transmits the instructions to the parking assistance device 34. The operation input unit 68 is not limited to the touch panel, and it may be a hardware switch of a push-button type, for example.

The parking assistance device 34 is a computer that includes a microcomputer such as an electronic control unit (ECU). The parking assistance device 34 acquires data of the captured images from the image capturing units 14. The parking assistance device 34 transmits to the monitoring device 32 the data that concerns images or sound generated based on the captured images and others. The parking assistance device 34 transmits to the monitoring device 32 the data that concerns images or sound such as instructions to the driver, notices to the driver, and others. The parking assistance device 34 controls the respective systems 22, 24, 26, and 28 via the in-vehicle network 36, thereby assisting the parking by performing automatic driving of the vehicle 10. The parking assistance device 34 includes a central processing unit (CPU) 34a, a read only memory (ROM) 34b, a random-access memory (RAM) 34c, a display controller 34d, an audio controller 34e, and a solid state drive (SSD) 34f. The CPU 34a, the ROM 34b, and the RAM 34c may be integrated in the same package.

The CPU 34a is one example of a hardware processor and reads out programs stored in a non-volatile storage device such as the ROM 34b and executes various arithmetic processes and control in accordance with the relevant programs. The CPU 34a executes image processing of images and others for parking assistance displayed on the display unit 64, for example.

The ROM 34b stores therein the respective programs, and parameters and others that are needed to execute the programs. The RAM 34c temporarily stores therein a variety of data used in the calculation in the CPU 34a. The display controller 34d mainly executes, out of the arithmetic processes in the parking assistance device 34, image processing of the images obtained by the image capturing units 14, data conversion of display images displayed on the display unit 64, and others. The audio controller 34e mainly executes, out of the arithmetic processes in the parking assistance device 34, processing of sound to be output to the audio output unit 66. The SSD 34f is a rewritable, non-volatile storage device and it retains data even when the power supply of the parking assistance device 34 is turned off.

The in-vehicle network 36 connects the wheel speed sensors 18, the braking system 22, the acceleration system 24, the steering system 26, the transmission system 28, the operation input unit 68 of the monitoring device 32, and the parking assistance device 34 so as to be able to transmit and receive information with one another.

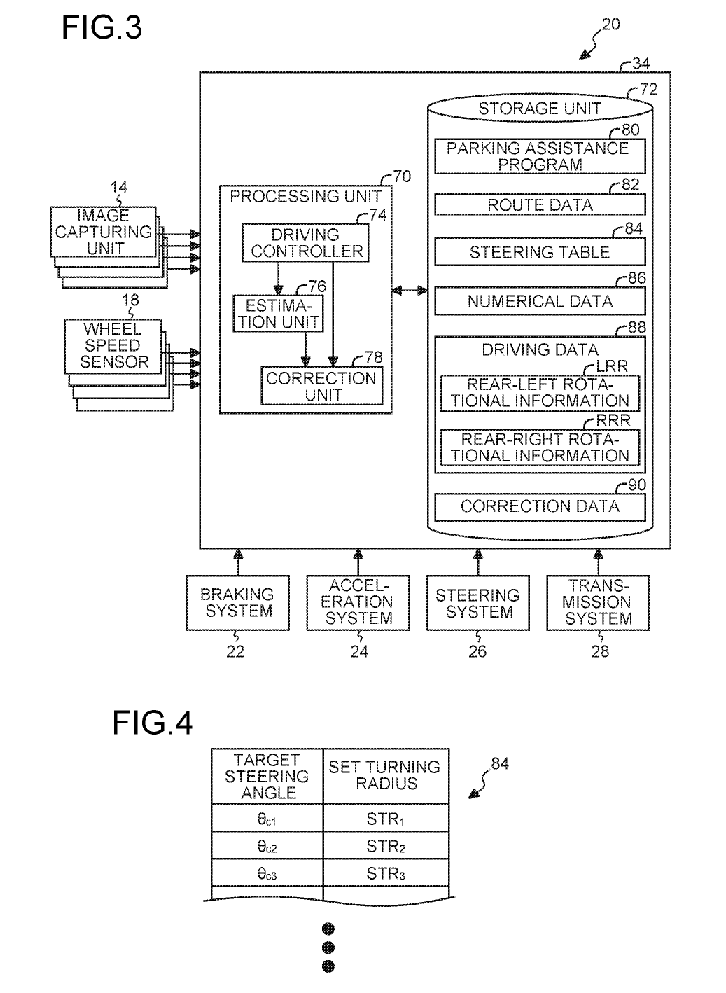

FIG. 3 is a functional block diagram for explaining the functions of the parking assistance device 34. As illustrated in FIG. 3, the parking assistance device 34 includes a processing unit 70 and a storage unit 72.

The processing unit 70 is implemented as the functions of the CPU 34a and others, for example. The processing unit 70 includes a driving controller 74, an estimation unit 76, and a correction unit 78. The processing unit 70 may implement the driving controller 74, the estimation unit 76, and the correction unit 78, by reading a parking assistance program 80 stored in the storage unit 72, for example. A part or a whole of the driving controller 74, the estimation unit 76, and the correction unit 78 may be configured by hardware such as a circuit including an application specific integrated circuit (ASIC).

The driving controller 74, in the parking assistance by automatic driving, based on route data 82 including a plurality of route patterns and others, sets a set route to a target point set in a parking area. The driving controller 74 sets the set route including a part of a turning circle (hereinafter referred to as set turning circle), for example. In the following description, the radius of the turning circle is described as a set turning radius. The driving controller 74 causes, by controlling any of the systems 22, 24, 26, and 28, the vehicle 10 to travel along the set route.

Specifically, the driving controller 74 steers, based on a preset steering table 84, the steering unit 12 so as to correspond to the set turning radius, thereby making the wheels 13FL and 13FR steer. The steering table 84 is a table in which a target steering angle and the set turning radius are associated with in advance. The target steering angle is a steering angle of the steering unit 12 to target in order to make the vehicle 10 travel along the set turning circle of the set turning radius. Accordingly, the driving controller 74 outputs a steering angle instructed to the steering system 26 so that the steering angle of the steering unit 12 results in the target steering angle associated with the set turning radius, thereby controlling the steering unit 12. Thus, the driving controller 74 causes the vehicle 10 to travel along the set turning circle on the set route.

The driving controller 74 acquires rotational information LRR and RRR, and others from the wheel speed sensors 18 via the in-vehicle network 36. The driving controller 74 controls, based on the moving distance calculated from the rotational information LRR and RRR, the timing of steering the steering unit 12, the timing of acceleration of the acceleration system 24, and others. Thus, the driving controller 74 causes the vehicle 10 to travel along the set route including the set turning circle.

The driving controller 74 stores in the storage unit 72 the information on the set route as a part of driving data 88. The information on the set route includes coordinates of a steering start point, coordinates of a steering end point, coordinates of a turnabout point, a target steering angle, an instructed steering angle, a set turning radius, coordinates of the center of a set turning circle, and others. The driving controller 74 acquires the rotational information LRR and RRR from the wheel speed sensors 18RL and 18RR in automatic driving, and stores in the storage unit 72 the rotational information LRR and RRR associated with the acquired time as a part of the driving data 88.

The estimation unit 76 estimates, based on the rear-left rotational information LRR on the wheel 13RL on the rear left that the wheel speed sensor 18RL detected and the rear-right rotational information RRR on the wheel 13RR on the rear right that the wheel speed sensor 18RR detected, a host-vehicle location that is the location of the vehicle 10 on a travel route that the vehicle 10 actually traveled, in a state of traveling along the set route.

For example, the estimation unit 76 estimates, based on the number of rear-left wheel speed pulses (hereinafter referred to as the number of rear-left pulses) corresponding to the number of revolutions of the rear-left wheel 13RL that the rear-left rotational information LRR indicates and the number of rear-right wheel speed pulses (hereinafter referred to as the number of rear-right pulses) corresponding to the number of revolutions of the rear right wheel 13RR that the rear-right rotational information RRR indicates, a plurality of host-vehicle locations on the travel route. The estimation unit 76 outputs to the correction unit 78, out of the host-vehicle locations, the coordinates of a stop location that is the end location of the travel route and that is the location of the vehicle 10 where the parking assistance is finished, for example.

The correction unit 78 calculates, based on a route difference that is the difference between the set route and the host-vehicle location on the travel route that the estimation unit 76 estimated, a correction value for correcting the set route in the next and subsequent parking assistance. For example, the correction unit 78 calculates the correction value based on the route difference between the target point and the actual stop location of the vehicle in the width direction of the parking area. The correction unit 78 may set, in the width direction (that is, the vehicle width direction of the vehicle 10 at the time of parking) of the parking area where the target point is set, a correction value for offsetting at least a part of the set route. For example, the correction unit 78 may calculate, as the correction value, a value for offsetting a point on the set route (hereinafter referred to as an offset point) in the width direction of the parking area. The offset point is the point of one or more, out of a steering start location in moving forward, a turn-back location in moving forward, a turnabout location, a steering start location in moving backward, a turn-back location in moving backward, and the target point. The correction unit 78 stores in the storage unit 72 correction data 90 including the calculated correction value.

When the correction data 90 including the correction value is stored in the storage unit 72, the driving controller 74 corrects, after having set a set route of parking assistance based on the route data 82, the set route by offsetting the offset point on the relevant set route by the correction value in the width direction of the parking area. The driving controller 74 performs automatic driving based on the relevant corrected set route, thereby assisting the parking.

The storage unit 72 is implemented as a function of at least one of the ROM 34b, the RAM 34c, and the SSD 34f. The storage unit 72 may be provided on an external network and the like. The storage unit 72 stores therein the programs that the processing unit 70 executes, the data that are needed to execute the programs, and the data and others that are generated by executing the programs. The storage unit 72 stores therein the parking assistance program 80 that the processing unit 70 executes, for example. The storage unit 72 stores therein the route data 82 including route patterns, the steering table 84, and numerical data 86 including thresholds, mathematical expressions, and others that are needed to execute the parking assistance program 80. The storage unit 72 stores therein the driving data 88 and the correction data 90 that were generated by executing the parking assistance program 80. The driving data 88 includes information on a set route, a target steering angle, an instructed steering angle output to the steering unit 12 at each time, a detected steering angle at each time, the rotational information LRR and RRR including the wheel speed pulses acquired from the wheel speed sensors 18RL and 18RR at each time, and others. The correction data 90 includes values calculated in the course of calculating the correction value together with the correction value.

FIG. 4 is a diagram illustrating one example of the steering table 84. As illustrated in FIG. 4, the steering table 84 associates a target steering angle θ_{cn} with a set turning radius STRₙ where n=1, 2, and so on. The driving controller 74 extracts from the steering table 84 a target steering angle θ_{cn} associated with a set turning radius STRₙ of a set turning circle included in the set route. The driving controller 74 outputs to the steering system 26 an instructed steering angle that results in the extracted target steering angle θ_{cn}, thereby causing the vehicle 10 to travel along the set turning circle.

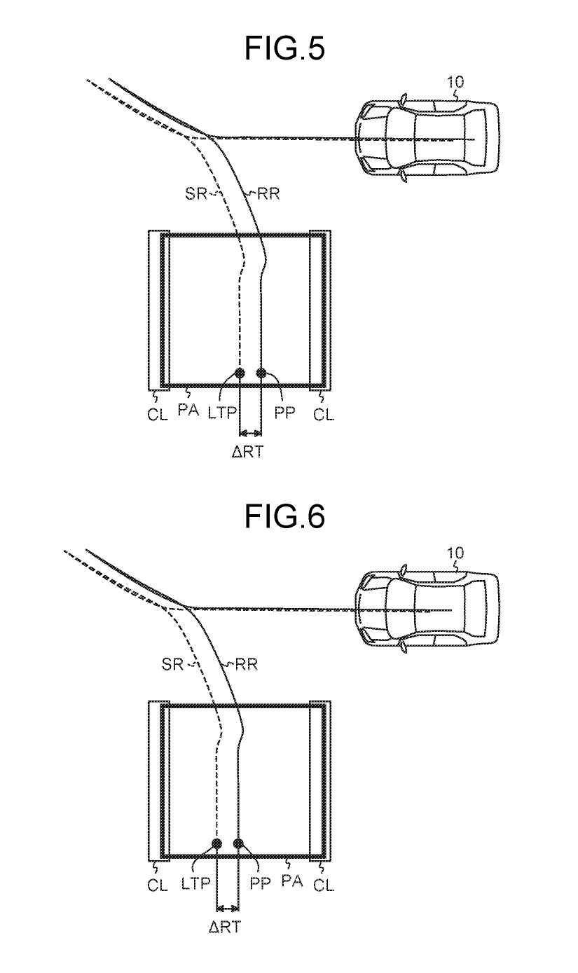

FIG. 5 is a diagram illustrating the set route SR before correction and a travel route RR. As illustrated in FIG. 5, the driving controller 74 detects, based on images of compartment lines CL acquired from the image capturing units 14, a parking area PA. The driving controller 74 sets, based on the route data 82, the set route SR (see the broken line) to a target point LTP set in the relevant parking area PA. The driving controller 74 controls, based on the target steering angle θ_{cn} of the steering table 84 associated with the set turning radius that the set route SR indicates, the steering unit 12 and others of the steering system 26 of the vehicle 10, thereby performing the automatic driving of the vehicle 10 to the target point LTP.

The vehicle 10 travels along the set route SR including a part of the set turning circle when the automatic driving is performed, as long as the relation between the set turning radius STRₙ and the target steering angle θ_{cn} of the steering unit 12 indicated in the steering table 84 is accurate. However, due to the characteristics of each vehicle 10, the surrounding environment of the vehicle 10, or the like, the actual relation between the target steering angle θ_{cn} and the set turning radius STRₙ may be different from the relation of the steering table 84, and thus, the vehicle 10 may, as illustrated in FIG. 5, travel along the travel route RR (see the fine solid line) that is different from the set route SR.

Consequently, the estimation unit 76 estimates, based on the rotational information LRR and RRR, a stop location PP or the like that is the target point of the travel route RR as the host-vehicle location. The correction unit 78 calculates a difference between the relevant stop location PP and the target point LTP as a route difference ΔRT and, based on the route difference ΔRT, calculates the correction value for offsetting the set route SR.

FIG. 6 is a diagram illustrating the set route SR after correction and the travel route RR. As illustrated in FIG. 6, the driving controller 74 corrects the set route SR based on the correction value that the correction unit 78 calculated from the route difference ΔRT. Specifically, the driving controller 74 offsets the set route SR, by the correction value, along the width direction of the parking area PA. For example, when the stop location PP is displaced to the right-hand direction with respect to the target point LTP, the driving controller 74 offsets the set route SR to the left-hand direction. Meanwhile, when the stop location PP is displaced to the left-hand direction with respect to the target point LTP, the driving controller 74 offsets the set route SR to the right-hand direction. The driving controller 74 can, by performing the automatic driving on the vehicle 10 based on the offset set route SR, park the vehicle 10 at the stop location PP that is offset from the target point LTP by the correction value, that is, the center position in the width direction of the parking area PA (the target point LTP in FIG. 5) that is an ideal location.

The correction unit 78 may, not adopting all of the calculated route difference ΔRT for the calculation of the correction value, based on predetermined conditions, determine adoption or rejection of the relevant route difference ΔRT. One example of the adoption conditions are as follows.

First adoption condition: The vehicle speed is below a preset vehicle speed threshold.

Second adoption condition: The route difference is below a first difference threshold.

Third adoption condition: The difference between the target point and the actual stop location of the vehicle in the length direction of the parking area is below a second difference threshold.

When one or more of the above-described three adoption conditions are satisfied, the correction unit 78 may adopt the calculated route difference ΔRT and, based on the relevant route difference ΔRT, calculate the correction value. Accordingly, the correction unit 78 reduces the influence of the route difference ΔRT, for which the probability of an inappropriate resultant value is high, on the correction value. The first difference threshold and the second difference threshold may be set as appropriate depending on the estimation accuracy and they may be stored as a part of the numerical data 86. The second difference threshold is one example of a difference threshold.

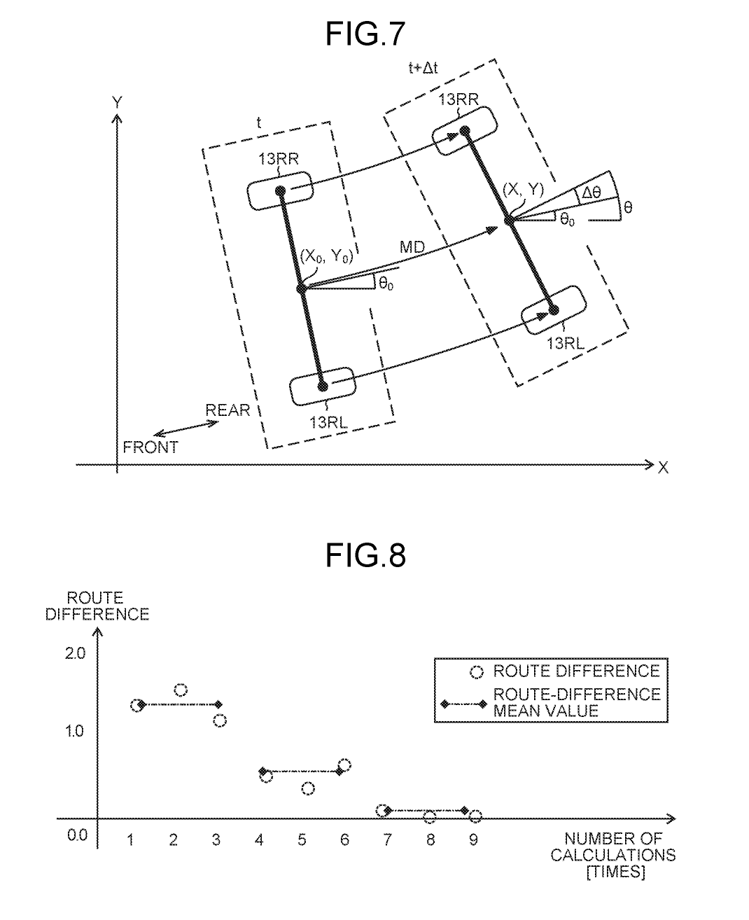

FIG. 7 is a diagram for explaining one example of a method of estimating the host-vehicle location by the estimation unit 76. The estimation unit 76 may estimate the host-vehicle location on the travel route RR by a known method (for example, Japanese Patent Application Laid-open No. 2015-075337) as illustrated in FIG. 7 using the rotational information LRR and RRR. FIG. 7 illustrates that the vehicle 10 facing a direction θ₀ at the location of coordinates (X₀,Y₀) at time t has moved to coordinates (X,Y) at time (t+Δt) and faced a direction θ. During time Δt, when it is assumed that the center of turning and the turning radius of the vehicle 10 are not changed and the vehicle 10 linearly moves, a moving distance MD of the vehicle 10 can be expressed by the following expressions.

MD=k(N_{L}+N_{R})/2

k: coefficient of converting the number of pulses into moving distance

N_{L}: the number of rear-left pulses during Δt

N_{R}: the number of rear-right pulses during Δt

When it is defined that X=X₀+ΔX and Y=Y₀+YΔ, the ΔX and ΔY can be expressed by the following expressions.

ΔX=MD cos θ₀=(k(N_{L}+N_{R})/2)cos θ₀ Expression 1

ΔY=MD sin θ₀=(k(N_{L}+N_{R})/2)sin θ₀ Expression 2

The direction θ of the vehicle 10 at time (t+Δt) can be expressed by the following expression.

θ=θ₀+Δθ=θ₀+k·Δt(N_{L}−N_{R})/TW Expression 3

TW: tread width

The estimation unit 76 detects, by calculating the host-vehicle location for each time Δt by using Expression 1, Expression 2, and Expression 3, the host-vehicle location of the stop location PP and the like on the actual travel route RR of the vehicle 10.

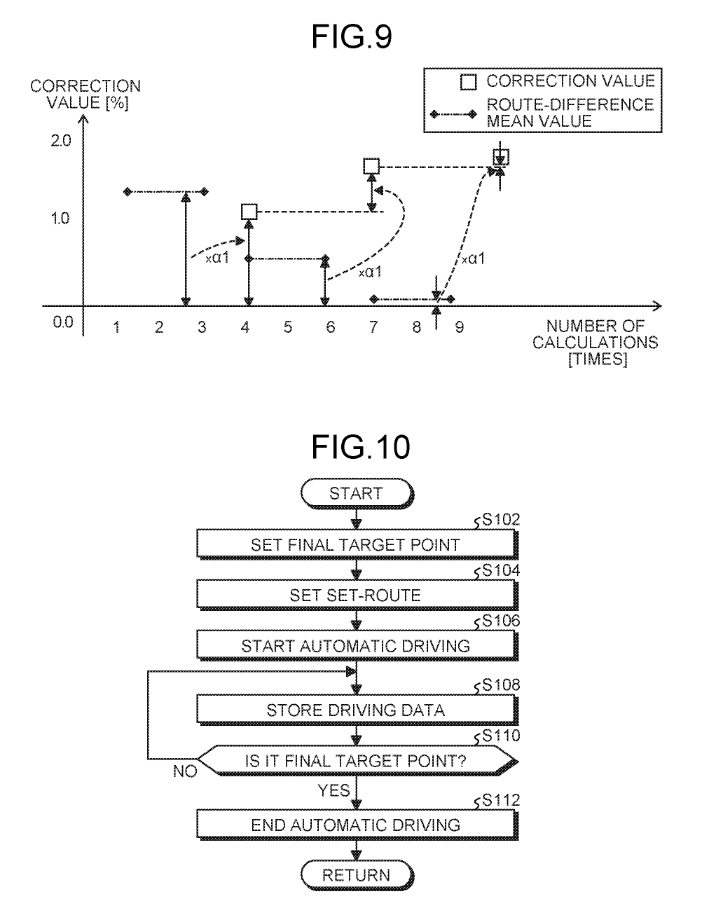

FIG. 8 is a graph illustrating the relation between a route-difference mean value and the number of times of calculation. FIG. 9 is a graph illustrating the relation between a correction value and the number of times of calculation. The route-difference mean value is an mean value (for example, an arithmetic mean value) of the route differences ΔRT. The number of times of calculation is the number of times the correction value was calculated by adopting the route difference ΔRT that satisfied the adoption conditions, out of the number of times of parking by the automatic driving.

As illustrated in FIG. 8, the correction unit 78 calculates, for each parking, the route difference ΔRT that is the difference between the target point LTP of the set route SR, which was acquired from the driving controller 74, and the stop location PP that the estimation unit 76 estimated.

The correction unit 78 calculates the route-difference mean value that is the mean value of the route differences ΔRT each time the number of times of calculation of the route difference ΔRT reaches a predetermined set mean number of times. One example of the set mean number of times is three times.

The correction unit 78 may calculate the route-difference mean value, by storing, into the storage unit 72, the number of times of calculation and an interim mean value calculated by averaging the route differences ΔRT each time the coordinates of the stop location PP are acquired from the estimation unit 76, until the number of times of calculation reaches the set mean number of times. Specifically, when the coordinates of the stop location PP in the first parking are acquired from the estimation unit 76, the correction unit 78 stores in the storage unit 72 an interim mean value (the first route difference ΔRT), and “1” as the number of times of calculation, as a part of the correction data 90. Then, when the coordinates of the stop location PP in the second parking are acquired from the estimation unit 76, the correction unit 78 stores in the storage unit 72 the interim mean value of the first and the second route differences ΔRT, and “2” as the number of times of calculation, and deletes from the storage unit 72 the previous interim mean value (the first route difference ΔRT), and “1” as the number of times of calculation previously stored. Thereafter, by repeating the same processing, when the coordinates of the stop location PP in the M-th parking are acquired from the estimation unit 76, the correction unit 78 calculates, as a new interim mean value, a value for which a product of the interim mean value and “M−1”, which is the number of times of calculation already stored in the storage unit 72, and the present route difference ΔRT are summed, and are divided by “M” that is the present number of times of calculation. The correction unit 78 stores in the storage unit 72 as the correction data 90 the interim mean value of the first to the M-th route differences ΔRT, and “M” as the number of times of calculation, and deletes from the storage unit 72 the previous interim mean value (the mean value of M−1 pieces of route differences ΔRT), and “M−1” as the number of times of calculation previously stored. Accordingly, the correction unit 78 can reduce the capacity of the storage unit 72 needed for the correction.

When the number of times of calculation reaches the set mean number of times, the correction unit 78 calculates, as a route-difference mean value, a value for which the product, which is obtained by multiplying the number of times of calculation (the set mean number of times—1) stored in the storage unit 72 by the interim mean value, and the present route difference ΔRT are summed, and are divided by the set mean number of times. In addition, the correction unit 78 resets the number of times of calculation to “0”. The correction unit 78 stores in the storage unit 72 the route-difference mean value as a part of the correction data 90.

As illustrated in FIG. 9, the correction unit 78 calculates an interim correction value by multiplying the route-difference mean value by a first correction coefficient al. The correction unit 78 calculates the correction value based on the relevant interim correction value. The first correction coefficient α1 is a positive value below one and, for example, is “0.8”.

The correction unit 78 may calculate the correction value based on the interim correction value that is obtained by multiplying the route-difference mean value by a second correction coefficient α2 smaller than the first correction coefficient α1 when the variance of the route-difference mean value is equal to or greater than a preset variance threshold. The second correction coefficient α2 is assumed to be, for example, “0.2”. Accordingly, the correction unit 78 reduces the influence of the route difference ΔRT and the route-difference mean value, which result in abnormal values when the surrounding situation of the vehicle 10 is peculiar (for example, in a case of a sloping road and the like), on the correction value.

The correction unit 78, when an interim correction value is calculated by multiplying the route-difference mean value by either of the correction coefficients α1 and α2, calculates a new correction value by adding the relevant interim correction value to the correction value that is the sum total for which all the interim correction values that have already been calculated were added. In the first set mean number of times, the interim correction value will be the correction value. The correction unit 78 stores in the storage unit 72 the calculated correction value as a part of the correction data 90.

When the correction unit 78 sets the correction value, the driving controller 74 performs the automatic driving of the vehicle 10 based on the set route SR that was corrected by offsetting by the correction value. Accordingly, after the correction value is set (in the example illustrated in FIG. 8, the number of times of calculation is four times or more), the route difference ΔRT becomes smaller and gets closer to “0”.

Thereafter, as with the processing until the above-described set mean number of times (the third time illustrated in FIG. 8), the correction unit 78 calculates a new route-difference mean value by repeating, based on the route difference ΔRT acquired from the estimation unit 76, the calculation of the interim mean value until a subsequent set mean number of times (the sixth time illustrated in FIG. 8). The route-difference mean value that was calculated in the second set mean number of times is smaller than the route-difference mean value that was calculated in the first set mean number of times, and it is closer to “0”. However, because the automatic driving of the vehicle 10 is performed based on the correction value for which the route-difference mean value is multiplied by the first correction coefficient α1 that is smaller than one, the route-difference mean value that was calculated in the second set mean number of times will not normally result in “0”. Thereafter, as illustrated in FIG. 9, the correction unit 78 calculates an interim correction value that is a product of the route-difference mean value, which was calculated in the second set mean number of times, and the first correction coefficient α1 (or the second correction coefficient α2). The correction unit 78 calculates the sum of the relevant interim correction value and the correction value that was calculated in the first set mean number of times, as a new correction value.

The correction unit 78, by repeating the same processing, calculates a new route-difference mean value and an interim correction value for each parking of the set mean number of times, and calculates the sum of the relevant interim correction value and the previous correction value as a new correction value. In other words, the correction unit 78 calculates the correction value by accumulating the interim correction values calculated for each set mean number of times. Accordingly, the route-difference mean value gradually becomes smaller and gets closer to “0”. The correction unit 78 stores in the storage unit 72 the calculated correction value as a part of the correction data 90.

FIG. 10 is a flowchart of driving control processing in parking assistance processing that the driving controller 74 of the processing unit 70 executes. For example, in a state in which an image of the parking area PA and others for receiving instructions of automatic driving is displayed on the display unit 64, when the instructions of automatic driving from the driver are received from the operation input unit 68, the driving controller 74 starts the driving control processing.

As illustrated in FIG. 10, in the driving control processing of the parking assistance processing, the driving controller 74 sets the target point LTP (S102). For example, the driving controller 74 detects the parking area PA based on the captured images acquired from the image capturing units 14 and sets the target point LTP within the parking area PA with the current location of the vehicle 10 as a reference.

The driving controller 74 sets, based on the route data 82, the set route SR from the current location of the vehicle 10 to the target point LTP (S104). The driving controller 74 controls at least one of the systems 22, 24, 26, and 28, and starts the automatic driving to the target point LTP (S106). The driving controller 74, when the correction value is already stored in the storage unit 72, controls the systems 22, 24, 26, and 28 based on the set route SR that has been corrected by offsetting the offset point by the relevant correction value.

The driving controller 74 stores the driving data 88 in the storage unit 72 during the automatic driving (S108). For example, the driving controller 74 stores in sequence the driving data 88 that includes the information on the set route SR, the rotational information LRR and RRR including the wheel speed pulses acquired from the wheel speed sensors 18RL and 18RR at each time, and others. The driving controller 74 sequentially stores the driving data 88 in the storage unit 72 while continuing the automatic driving, until the target point LTP is reached (No in S110).

The driving controller 74, when the target point LTP is reached (Yes in S110), ends the automatic driving (S112) and waits until the subsequent driving control processing.

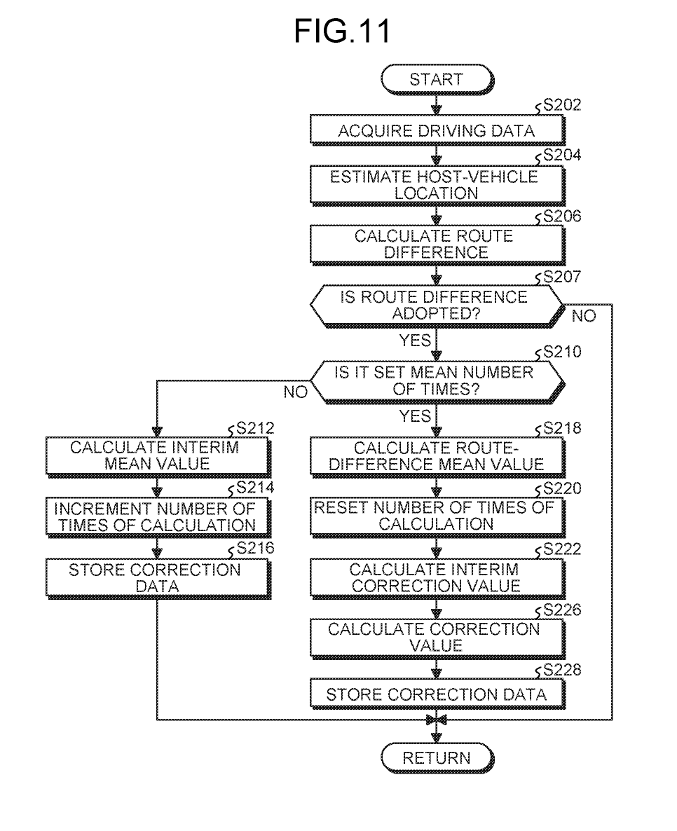

FIG. 11 is a flowchart of correction processing in the parking assistance processing that the estimation unit 76 and the correction unit 78 of the processing unit 70 execute.

As illustrated in FIG. 11, in the correction processing of the parking assistance processing, the estimation unit 76 acquires the driving data 88 stored in the storage unit 72 (S202).

The estimation unit 76 estimates, from the driving data 88 and from the method illustrated in FIG. 7, the host-vehicle location (for example, the stop location PP) on the travel route RR for which the vehicle 10 actually traveled by automatic driving based on the set route SR (S204).

The correction unit 78 calculates the route difference ΔRT, from the coordinates of the target point LTP included in the driving data 88 and the coordinates of the stop location PP acquired from the estimation unit 76 (S206).

The correction unit 78 determines whether to adopt the route difference ΔRT for the calculation of the correction value (S207). Specifically, the correction unit 78 may determine, based on the above-described first adoption condition to the third adoption condition, whether to adopt the route difference ΔRT.

When determined not to adopt the route difference ΔRT (No in S207), the correction unit 78 ends the correction processing without calculating a new correction value, and it turns into a state of standby until the subsequent driving control processing is executed.

Meanwhile, when determined to adopt the route difference ΔRT (Yes in S207), the correction unit 78 determines whether the number of times of calculation of the route difference ΔRT is the set mean number of times (S210).

When determined that the number of times of calculation of the route difference ΔRT is not the set mean number of times (No in S210), the correction unit 78 calculates an interim mean value of the route differences ΔRT (S212). The correction unit 78 increments the number of times of calculation by 1 (S214). The correction unit 78 stores in the storage unit 72, as the correction data 90, the number of times of calculation and the interim mean value (S216). Accordingly, the estimation unit 76 and the correction unit 78 end the correction processing, and they turn into a state of standby until the subsequent driving control processing is executed.

Meanwhile, when determined that the number of times of calculation of the route difference ΔRT is the set mean number of times (Yes in S210), the correction unit 78 calculates a route-difference mean value (S218). Specifically, the correction unit 78 calculates the sum of a product, which is obtained by multiplying the number of times of calculation (the set mean number of times—1) stored in the storage unit 72 by the interim mean value, and the present route difference ΔRT. The correction unit 78 calculates, as the route-difference mean value, a value obtained by dividing the relevant sum by the set mean number of times. The correction unit 78 resets the number of times of calculation (S220).

The correction unit 78 calculates an interim correction value based on the route-difference mean value (S222). Specifically, the correction unit 78 calculates, as the interim correction value, a product of the route difference and any of the correction coefficients α1 and α2. The correction unit 78 may select, based on the variance of the route difference ΔRT and the route-difference mean value, the correction coefficients α1 and α2.

The correction unit 78 calculates the correction value based on the calculated interim correction value (S226). Specifically, the correction unit 78 calculates, as a new correction value, the sum obtained by adding the present interim correction value to the correction value that is already stored in the storage unit 72. The correction unit 78 stores in the storage unit 72 the calculated new correction value, and the number of times of calculation that was reset, as the correction data 90 (S228). Accordingly, the estimation unit 76 and the correction unit 78 end the correction processing, and they turn into a state of standby until the subsequent driving control processing is executed.

As in the foregoing, in the parking assistance system 20, the wheel speed sensors 18RL and 18RR detect the rotational information LRR and RRR concerning the actual rotation of the left and right wheels 13RL and 13RR, and the processing unit 70 calculates the correction value based on the stop location PP estimated from the relevant rotational information LRR and RRR, thereby correcting the set route SR. Accordingly, the parking assistance system 20 can, as compared with a case in which the host-vehicle location of the stop location PP and others is estimated based on the instructed steering angle or the detected steering angle which is influenced by the characteristics and the like of the vehicle 10, correct the set route SR more accurately and cause the vehicle 10 to travel to an ideal location in the parking area PA.

In the parking assistance system 20, the processing unit 70 corrects, in the width direction of the parking area PA, the set route SR by offsetting the offset point based on the correction value calculated from the route difference ΔRT. Accordingly, the parking assistance system 20 can set the appropriate set route SR while suppressing an increase in calculation load of the correction processing.

In the parking assistance system 20, the processing unit 70 calculates the correction value by multiplying the route-difference mean value by the first correction coefficient α1 below one. Accordingly, even when the route-difference mean value has resulted in an abnormal value, the parking assistance system 20 can reduce the influence of the abnormal value on the correction value.

In the parking assistance system 20, when the variance of the route difference and the route-difference mean value is large, the processing unit 70 calculates the correction value by multiplying the route-difference mean value by the second correction coefficient α2 smaller than the first correction coefficient α1. Accordingly, the parking assistance system 20 can reduce the inappropriate influence, which increases when the variance of the route-difference mean value is large, on the correction value.

In the parking assistance system 20, because the correction value is calculated based on the difference between the target point LTP and the stop location PP in the vehicle width direction of the parking area PA, the target point LTP and the stop location PP can be made closer.

In the parking assistance system 20, because the correction value is calculated by adopting the route difference ΔRT in the case in which the vehicle speed is below the vehicle speed threshold, the accuracy of the correction value can be improved by the route difference ΔRT in a low speed condition that is appropriate for the correction.

In the parking assistance system 20, the correction value is calculated by adopting the route difference ΔRT in the case in which the difference between the target point LTP and the stop location PP in the length direction of the parking area PA is below the second difference threshold. Accordingly, in the parking assistance system 20, by eliminating the route difference ΔRT that was increased by the factors other than the actual directions of the wheels 13, the accuracy of the correction value can be improved by the appropriate route difference ΔRT.

Next, modifications for which a part of the processing of the above-described embodiment was modified will be described.

First Modification

In the above-described embodiment, the correction unit 78 calculates, as the route difference ΔRT, the difference between the target point LTP and the stop location PP. However, the embodiment is not limited to this. For example, the correction unit 78 may calculate the route difference ΔRT based on a plurality of host-vehicle locations on the travel route RR.

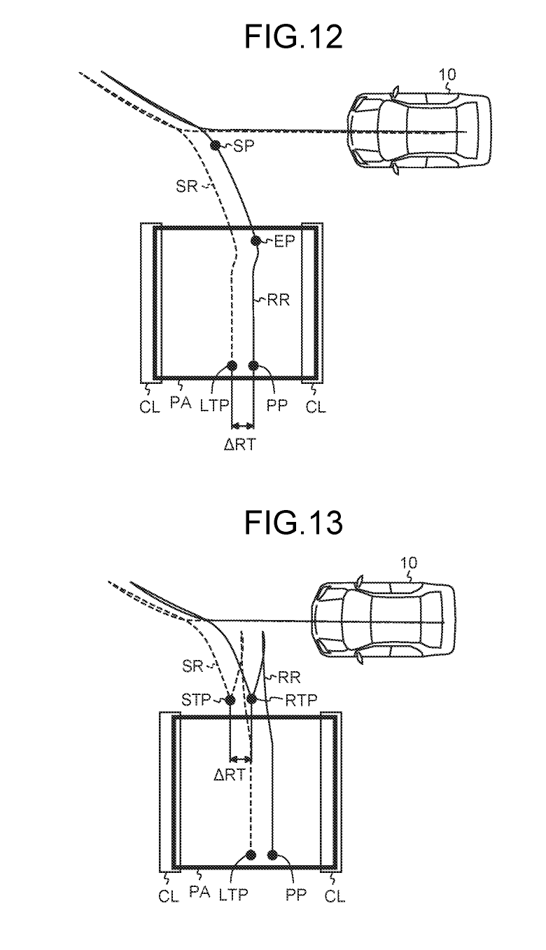

FIG. 12 is a diagram for explaining a method of calculating the route difference ΔRT in a first modification. As illustrated in FIG. 12, the estimation unit 76 may estimate a plurality of host-vehicle locations including the stop location PP and output the coordinates of the plurality of host-vehicle locations to the correction unit 78.

For example, the estimation unit 76 may estimate a start point SP and an end point EP as the host-vehicle locations at the time of moving backward. The estimation unit 76 may adopt, as the start point SP, a point at which a turning circle for which the turning radius is fixed starts in the set route SR. Specifically, the estimation unit 76 may adopt, as the start point SP, the host-vehicle location that satisfies the following start point conditions.

First start point condition: The instructed steering angle is fixed.

Second start point condition: The difference obtained by subtracting the instructed steering angle from the target steering angle is equal to or less than a first threshold residual error.

Third start point condition: The difference obtained by subtracting the detected steering angle from the instructed steering angle is equal to or less than a second threshold residual error.

The estimation unit 76 may set, as the end point EP, the point that is a point subsequent to the start point SP at which the steering angle of the steering unit 12 was fixed and that the steering angle was changed, that is, a point at which the turn-back was started. Furthermore, the estimation unit 76 may estimate the start point and the end point at the time of forward moving as the host-vehicle locations based on the same conditions as those at the time of moving backward. The estimation unit 76 may estimate a turnaround point as the host-vehicle location. The estimation unit 76 may estimate the host-vehicle location on the last straight line toward the target point LTP.

The correction unit 78 calculates, as the route differences ΔRT, the differences between the start point SP and the set route SR and between the end point EP and the set route SR. As just described, when a plurality of route differences ΔRT are calculated, the correction unit 78 may calculate the correction value with a median value (or an mean value) of the plurality of route differences ΔRT as a new route difference ΔRT.

Because the route difference ΔRT changes as it gets closer to the target point LTP, the correction unit 78 may calculate the correction value by multiplying the route difference ΔRT by a weight associated with each point. In addition, the correction unit 78 may, based on the changes in the route difference ΔRT, predict the route difference ΔRT at the target point LTP.

Second Modification

In the above-described embodiment, it has been exemplified that the estimation unit 76 and the correction unit 78 execute the correction processing after having completed the driving control processing. However, the embodiment is not limited to this. For example, the estimation unit 76 and the correction unit 78 may execute the correction processing in parallel with the driving control processing.

FIG. 13 is a diagram illustrating one example of the set route SR to which correction processing in a second modification is applied. As illustrated in FIG. 13, the estimation unit 76 and the correction unit 78 may execute the correction processing in parallel with the driving control processing that travels the set route SR including a turn-back point at the time of moving backward (hereinafter referred to as a set turn-back point STP).

In this case, the estimation unit 76 may estimate, as the host-vehicle location, a turn-back point at the time of moving backward on the actual travel route RR (hereinafter referred to as a travel turn-back point RTP) from the rotational information LRR and RRR. The correction unit 78 may, when acquired the coordinates of the travel turn-back point RTP from the estimation unit 76, calculate a difference between the set turn-back point STP and the travel turn-back point RTP as the route difference ΔRT, and calculate the correction value from the route difference ΔRT in the same method as the above-described method. The correction unit 78 in the second modification calculates the route difference ΔRT based on a difference calculation method in which the host-vehicle location is different from that of the first embodiment.

That is, the estimation unit 76 and the correction unit 78 in the second modification calculate the correction value for each pattern from the route difference ΔRT that is calculated based on the difference calculation method associated with each pattern of a plurality of patterns of the set route SR. The plurality of patterns include a route pattern in which there is no turn-back at the time of moving backward in the first embodiment, and a route pattern in which the turn-back at the time of moving backward in the second modification is present. The plurality of patterns, however, are not limited to this and may include other route patterns, and it is preferable that each of the relevant patterns be associated with the difference calculation method.

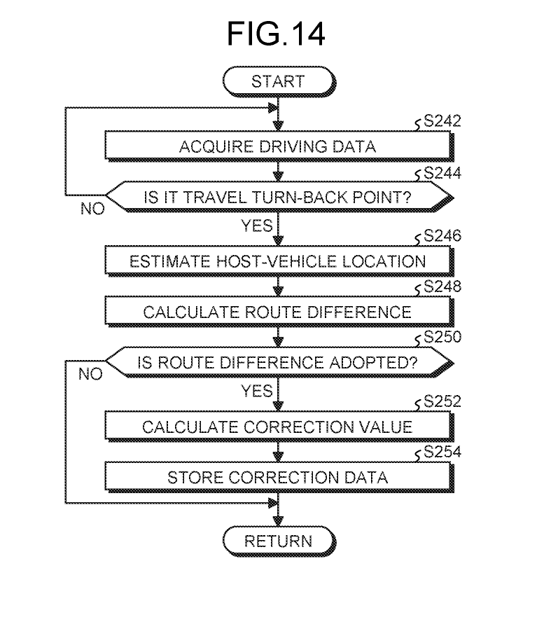

FIG. 14 is a flowchart of the correction processing in the second modification. As illustrated in FIG. 14, in the correction processing in the second modification, the estimation unit 76 acquires the driving data 88 including the rotational information LRR and RRR from the driving controller 74 or from the wheel speed sensors 18 in automatic driving (S242). The estimation unit 76 estimates, based on the driving data 88, whether the travel turn-back point RTP has been reached (S244). When determined that the travel turn-back point RTP has not been reached (No in S244), the estimation unit 76 repeats the acquisition of the driving data 88. When determined that the travel turn-back point RTP has been reached (Yes in S244), the estimation unit 76 estimates the coordinates of the host-vehicle location that is located at the travel turn-back point RTP (S246).

When acquired the coordinates of the travel turn-back point RTP from the estimation unit 76, the correction unit 78 calculates the route difference ΔRT (S248). The correction unit 78 determines whether to adopt the calculated route difference ΔRT (S250). When determined not to adopt the route difference ΔRT (No in S250), the correction unit 78 ends the correction processing, and turns into a state of standby until the subsequent driving control processing is executed.

When determined to adopt the route difference ΔRT (Yes in S250), the correction unit 78 calculates the correction value (S252). For example, when a plurality of route differences ΔRT have been calculated on the same route pattern in the past, the correction unit 78 may calculate a median value (or an mean value) of the plurality of route differences ΔRT as the correction value. The correction unit 78 stores in the storage unit 72 the correction value associated with the pattern of the set route SR as the correction data 90 (S254).

Thereafter, the driving controller 74 offsets, based on the correction value calculated by the correction unit 78, the target point LTP and resets the set route SR to the relevant target point LTP. The driving controller 74 executes, based on the set route SR that has been reset, the automatic driving after the turn-back at the time of moving backward.

As in the foregoing, in the parking assistance system 20 in the second modification, the processing unit 70 calculates the correction value from the route difference ΔRT that is calculated based on the difference calculation method associated with each pattern of the plurality of patterns of the set route SR. Accordingly, because an appropriate correction value can be calculated corresponding to the route difference ΔRT different for each pattern, the parking assistance system 20 can execute the parking assistance based on the set route SR more appropriately corrected for each pattern.

The respective functions, connection relations, numbers, arrangements, and others of the configurations of the above-described embodiment and modifications may be modified or deleted as appropriate within the scope of the invention and within the scope of equivalents thereof. The respective embodiment and modifications may be combined as appropriate. The order of the respective steps of the embodiment and modifications may be changed as appropriate.

In the above-described embodiment, the wheel speed pulses corresponding to the number of revolutions of the wheels 13 that the wheel speed sensors 18RL and 18RR detect have been exemplified as an example of the rotational information LRR and RRR. However, the embodiment is not limited to this. The rotational information LRR and RRR only needs to be a value associated with the number of revolutions of the wheels 13, and it may be the number of revolutions (or a rotation angle) of the motor, the engine, and the like for rotating the wheels 13, for example.

In the above-described embodiment, it has been exemplified that the correction unit 78 calculates the correction value by multiplying the route-difference mean value by the correction coefficient α1 or α2. However, the embodiment is not limited to this. The correction unit 78 may calculate the correction value by multiplying the route difference ΔRT by the correction coefficient α1 or α2.

In the above-described embodiment, it has been exemplified that the correction unit 78 calculates the correction value for offsetting in the width direction of the parking area PA. However, the embodiment is not limited to this. For example, the correction unit 78 may calculate the respective correction values for offsetting in the width direction and the length direction of the parking area PA.

In the above-described embodiment, the correction in bay parking (double-parking) has been exemplified. However, the above-described correction may be applied to other parking such as parallel parking.

In the above-described embodiment, it has been exemplified that the estimation unit 76 estimates the host-vehicle location based on the rotational information LRR and RRR on the rear wheel speed sensors 18RL and 18RR. However, the host-vehicle location may be estimated based on the rotational information on the wheel speed sensors 18FL and 18FR.

In the above-described embodiment, the rotational information concerning the rotation of the wheels 13 has been exemplified as the first information and the second information. However, the first information and the second information are not limited to this. For example, the first information and the second information may be the actual steering angle of the wheel 13 on the left-hand side and the steering angle of the wheel 13 on the right-hand side. The steering angles of the left and right wheels 13 may be detected by an angle sensor or the like.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A parking assistance system comprising:
a first detector configured to detect first information that is information concerning a wheel on a left-hand side of a vehicle;
a second detector configured to detect second information that is information concerning a wheel on a right-hand side of the vehicle; and
a processor configured to estimate a host-vehicle location that is a location of the vehicle based on the first information and the second information in a state of traveling along a set route to a target point set in a parking area, and to calculate a correction value for correcting the set route based on a route difference that is a difference between the set route and the host-vehicle location.

2. The parking assistance system according to claim 1, wherein the processor makes correction by offsetting at least a part of the set route in a width direction of the parking area based on the correction value.

3. The parking assistance system according to claim 1, wherein the processor calculates the correction value based on an interim correction value obtained by multiplying a route-difference mean value that is an mean value of the route differences, by a first correction coefficient below one.

4. The parking assistance system according to claim 3, wherein the processor calculates the correction value based on the interim correction value that is obtained by multiplying the route-difference mean value by a second correction coefficient smaller than the first correction coefficient when variance of the route difference or the route-difference mean value is equal to or greater than a preset variance threshold.

5. The parking assistance system according to claim 1, wherein the processor calculates the correction value for each pattern of a plurality of patterns of the set route from the route difference calculated based on a difference calculation method associated with each pattern.

6. The parking assistance system according to claim 1, wherein the processor calculates the correction value based on a difference between the target point and an actual stop location in a vehicle width direction of the parking area.

7. The parking assistance system according to claim 1, wherein the processor calculates the correction value by adopting the route difference of a case in which a vehicle speed of the vehicle is below a preset vehicle speed threshold.

8. The parking assistance system according to claim 1, wherein the processor calculates the correction value by adopting the route difference of a case in which a difference between the target point and an actual stop location in a length direction of the parking area is below a difference threshold.
